(19) United States
(12) Patent Application Publication
(10) Pub. No.: US 2015/0171684 A1
(43) Pub. Date: Jun. 18, 2015

(54) ROTOR OF A ROTATING MACHINE WITH FLUX CONCENTRATION

(71) Applicant: MOTEURS LEROY-SOMER, Angouleme (FR)

(72) Inventors: Michael Leo McClelland, Nommay (FR); Xavier Jannot, Angouleme (FR); Michel Labonne, Ruelle-Sur Touvre (FR)

(21) Appl. No.: 14/377,618

(22) PCT Filed: Feb. 19, 2013
(86) PCT No.: PCT/IB2013/051336

§ 371 Date: Aug. 8, 2014

(30) Foreign Application Priority Data
Feb. 20, 2012 (FR) 1251530

(51) Int. Cl. H02K 1/27

(52) U.S. Cl. CPC H02K 1/2786; H02K 2201/03

(57) ABSTRACT

A rotor of a rotating electric machine with flux concentration, including: a rotor body including recesses, and permanent magnets arranged in the recesses of the rotor body, said permanent magnets being arranged in the shape of a V oriented towards the air gap, each V defining an elementary polar portion, at least two consecutive elementary polar portions having an identical polarity.

The present invention relates to rotating electric machines, in particular synchronous machines, including motors, and more particularly the rotors of such machines. The invention concerns permanent magnet rotors and rotors with flux concentration. Rotors with flux concentration comprise a rotor body in which permanent magnets are housed, said magnets being engaged in recesses most often oriented radially.

Electric machines comprising non-radial permanent magnets arranged for example in the shape of a V or U are known, as in patents EP 1 414 130, U.S. Pat. No. 6,984,909, U.S. Pat. No. 6,836,045, U.S. Pat. No. 6,794,784, U.S. Pat. No. 6,909,216, U.S. Pat. No. 5,955,807, and patent application US 2008/231135.

Thanks to the flux concentration in the poles, the induction obtained in the air gap is greater than the induction in the magnets. The induction obtained in the air gap may be highly dependent on the circumferential position.

In application US 2007/014850 and in international application WO 2010/039786, the permanent magnets are arranged in two concentric layers.

In the known rotors, in order to obtain sufficient induction levels in the air gap and to have compact machines, it may be necessary to use magnets with high energy density and which are therefore costly. In fact, such magnets are fabricated using rare earths.

In other machines, magnets with low energy density and which are made of ferrite are used, however such machines have the disadvantage of requiring an increased polarity or rotors with a very large diameter in order to obtain induction levels in the air gap that are comparable to that which can be obtained using magnets with high energy density.

A machine with increased polarity requires high frequencies, thus resulting in significant losses in the motor in the form of iron losses and in the inverter in the form of switching losses. Such machines with increased polarity and with magnets with low energy density are therefore used at limited speeds.

Thus, the rotors of rotating electric machines with flux concentration do not make it possible to provide machines with relatively low polarity, for example lower than six, with effective use of magnets, in particular magnets made of ferrite and/or with low energy density.

There is thus a need to provide a rotor of a rotating electric machine allowing a more effective use of permanent magnets, in particular magnets made of ferrite and/or with low energy density, and possibly with a polarity that is not necessarily increased.

The object of the invention is to meet this need wholly or in part, and the invention achieves this, in accordance with one of its features, thanks to a rotor for a rotating electric machine with flux concentration, comprising:
a rotor body comprising recesses, and
permanent magnets arranged in the recesses of the rotor body, the permanent magnets being arranged in the shape of a V oriented toward the air gap, each V defining an elementary polar portion, at least two consecutive elementary polar portions having an identical polarity.

The rotor body defines elementary polar portions each arranged between magnets polarized symmetrically relative to one another, which make it possible to effectively concentrate the flux of the magnets. Thanks to the elementary polar portions, the invention makes it possible to improve the induction obtained in the air gap whatever the circumferential position.

A plurality of consecutive elementary polar portions, by juxtaposition, define a primary pole of the rotor. The number of elementary polar portions in a primary pole is greater than or equal to two, for example three, four or five. When the number of elementary polar portions is equal to two, the magnets defining the same pole are arranged in the shape of a W. At least three consecutive elementary polar portions may have an identical polarity, or at least four consecutive elementary polar portions, or even five consecutive elementary polar portions.

Thanks to the arrangement of the magnets in the rotor body, induction levels in the air gap that are sufficient even with a relatively low polarity of the rotor, for example less than 6, are obtained, whilst not necessarily using magnets with high energy density, such as magnets made of rare earths, but by contrast by using magnets with low energy density, for example made of ferrite. The cost of the rotor may thus be reduced. In addition, the polarity of the rotor may be reduced if required by the application. In fact, the rotor according to the invention makes it possible to increase the level of induction in the air gap without increasing the polarity and by using magnets with low energy density.

The expression “V oriented toward the air gap” means that the V is open in the direction of the air gap. A V may be formed by two consecutive permanent magnets as considered circumferentially. In a variant, a V may be formed by more than two permanent magnets as considered circumferentially, in particular by four permanent magnets, two magnets for example forming each branch of the V. Such a segmentation of the magnets may make it possible to improve the flux circulation in the rotor body and/or to introduce bridges to as to add rigidity to the rotor body.

One branch of a V may be formed by a number of magnets, for example two. Two magnets of one branch of the V may be aligned. In a variant, the magnet or magnets forming one branch of a V may each extent along an axis, the two axes enclosing an angle α therebetween. This angle α may be between 0° and 45°.

The permanent magnets may be rectangular in cross section. In a variant, the width of a magnet in cross section perpendicularly to the axis of rotation may become thinner in the direction of the air gap. The permanent magnets may be generally trapezoidal in cross section. In a further variant, the magnets may be curved in cross section, for example in the shape of a sector of a ring.

Two consecutive magnets of two consecutive elementary polar portions of identical polarity may form a V oriented toward the axis of rotation. As considered circumferentially, the arrangement of the consecutive magnets may be identical when passing from one V to another V of the same pole rather than to a V or a pole of opposed polarity. Thus, two consecutive magnets of two consecutive elementary polar portions of opposed polarity may also form a V oriented toward the axis of rotation.

In a variant, the arrangement of the consecutive magnets may be different depending on whether passing to a V of the same pole or whether passing to a V of a pole of opposed polarity. This may make it possible to optimize the flux circulation in the rotor body. By way of example, two consecutive magnets of two consecutive elementary polar portions of opposed polarity may extend substantially parallel to one another. Such an arrangement of magnets makes it possible to optimize the flux circulation in the rotor body.

The thickness of the rotor body between two consecutive magnets of two consecutive elementary polar portions of opposed polarity may be less than 5 mm, or less than 3 mm, and even better less than 1.5 mm.

In a further variant, the same magnet may be involved in two consecutive Vs at the same time, in particular two Vs of two poles of opposed polarity. The magnet may in this case be twice as large in cross section than a magnet involved in just one V, for example.

A recess may extend radially over a length greater than the radial length of the corresponding magnet in cross section. The shape of the recess in cross section may be selected in order to optimize the waveform of the induction in the air gap. By way of example, at least one end of the recess in cross section perpendicularly to the axis of rotation may be triangular, or the two ends may be triangular or curved, or in the shape of a circular arc. When the magnet is inserted into the corresponding recess, the portion(s) of the recess without magnet at one of its ends may be triangular, rectangular or rounded. For two consecutive recesses, the hypotenuses of the two triangles, rectangles or the curve arranged closest to the air gap may be arranged opposite one another. Such a form makes it possible to better guide the magnetic flux toward the air gap. For two consecutive recesses, the hypotenuses of the two triangles, rectangles or the curves arranged closest to the axis of rotation may be arranged face to face.

The permanent magnets may form a number of Vs between 8 and 24, or between 12 and 20, for example 16. It may be possible to determine for a given rotor an optimum number of Vs making it possible to maximize the production of the flux in the air gap depending on the polarity of the rotor and on the geometrical dimensions thereof. The optimum number of Vs for a given polarity may be greater than the optimum number of Vs for a polarity greater than the given polarity, for example.

The number of poles of the rotor may be less than or equal to 8, or less than or equal to 6, for example equal to 4. Thanks to the invention, it is possible to provide a rotor with weak polarity, for example with just two poles, whilst producing an effective flux concentration. There is not necessarily any frequency limit for use, and the rotor according to the invention may be used by being supplied with power by an electronic power inverter, whilst limiting the iron losses at the motor and the switching losses in the inverter.

The permanent magnets of the rotor may be made at least in part of ferrite. For example, they may not contain rare earths, or at the very least may contain less than 50% of rare earths by weight.

The rotor may comprise a shaft extending along an axis of rotation. The shaft may be made of a magnetic material, which advantageously makes it possible to reduce the risk of saturation in the rotor body and to improve the electromagnetic performance of the rotor. The shaft may comprise a magnetic sleeve in contact with the rotor body, the sleeve being mounted on a spindle, which may or may not be magnetic.

The rotor body extends along the axis of rotation and is arranged around the shaft. The shaft may comprise torque transmission means for rotating the rotor body.

The rotor body may be formed entirely by an assembly of rotor laminations, each being formed in one piece, or by a winding of a strip of sectors. Thus, the rotor may be devoid of connected polar portions, and the construction of the rotor is thus simplified.

The stack of magnetic lamination layers may comprise a stack of magnetic laminations, each in one piece, each lamination forming a layer of the stack.

In a variant, the stack of magnetic lamination layers may comprise one or more wound magnetic lamination(s), each lamination possibly forming a number of layers of the stack in accordance with the number of turns by which it is wound.

A lamination may comprise a succession of sectors connected by material bridges. The material bridges may form the base of a recess of a permanent magnet, on the side of the air gap.

Each sector may correspond to an elementary polar portion. A lamination may comprise a number of sectors equal to the number of elementary polar portions, or, in a variant, to the number of poles of the rotor. A lamination may comprise a number of sectors greater than the number of elementary polar portions of the rotor, for example a multiple of the number of elementary polar portions of the rotor, two sectors of the same lamination being able to be superimposed one above the other when the lamination is wound to form the rotor body.

Each rotor lamination is, for example, cut from a sheet of magnetic steel, for example steel from 0.1 to 1.5 mm thick. The laminations may be coated by an electrically insulating varnish on their opposed faces prior to their assembly within the stack. The insulation may also be obtained by a heat treatment of the laminations.

In a variant, the rotor body may comprise polar portions independent of one another. Each polar portion may be formed from a stack of magnetic laminations.

At least one of the recesses may be of oblong shape, lengthened preferably in a rectilinear direction. All the recesses are preferably oblong in shape, lengthened in a rectilinear direction. In a variant, the recesses may be lengthened in a curved direction, for example in a circular arc.

The distribution of the recesses is advantageously regular and asymmetrical, facilitating the cutting of the rotor lamination and the mechanical stability after cutting when the rotor body is formed by a superimposition of rotor laminations.

The number of recesses and of magnets is dependent on the polarity of the rotor. The rotor body may comprise any number of recesses, for example between 4 and 96 recesses, even better between 8 and 40 recesses, or between 16 and 32 recesses.

The magnets may be buried in the rotor body. In other words, the magnets are covered by the layers of magnetic laminations at the air gap. The surface of the rotor at the air gap may be defined entirely by the edge of the layers of magnetic laminations and not by the magnets. The recesses then do not lead radially to the outside.

The rotor body may comprise one or more holes to lighten the rotor, enable the balancing thereof or for the assembly of the rotor laminations forming the rotor. Holes may allow the passage of tie rods, the laminations now being fixed to one another.

The layers of laminations may be clipped to one another.

The recesses may be filled at least in part by a non-magnetic synthetic material. This material may lock the magnets in place in the recesses and/or increase the cohesion of the laminated core.

The rotor body may comprise, if appropriate, one or more reliefs contributing to the correct positioning of the magnets, in particular in the radial direction.

The rotor body may have an outer contour that is circular or multilobed, a multilobed form potentially being useful, for example in order to reduce the torque waves or the current or voltage harmonics.

The rotor may receive an outer ring, which surrounds the laminated core. This may make it possible to reduce the width of the material bridge connecting two consecutive sectors.

The rotor may or may not be mounted askew.

The rotor may be made of a number of pieces of rotor aligned in the axial direction, for example three parts. Each of the parts may be offset angularly with respect to the other adjacent pieces (step skew).

The invention also relates to a rotating electric machine, such as a synchronous motor or a synchronous generator, comprising a rotor as defined above. The rotor may be an inner or outer rotor.

The use of an outer rotor may make it possible to avoid a potential saturation between consecutive magnets of identical polarity, this saturation potentially being produced with an inner rotor. It is thus possible to have a greater magnetic induction in the air gap. On the other hand, in a configuration with an outer rotor, there is more space to arrange the magnets, which makes it possible to increase the flux concentration factor in the air gap more easily.

This machine may comprise a stator with concentrated or distributed winding.

The rotor may have as many primary poles as the stator.

The invention will be better understood upon reading the following detailed description of non-limiting exemplary embodiments thereof, and upon examination of the accompanying drawing, in which:

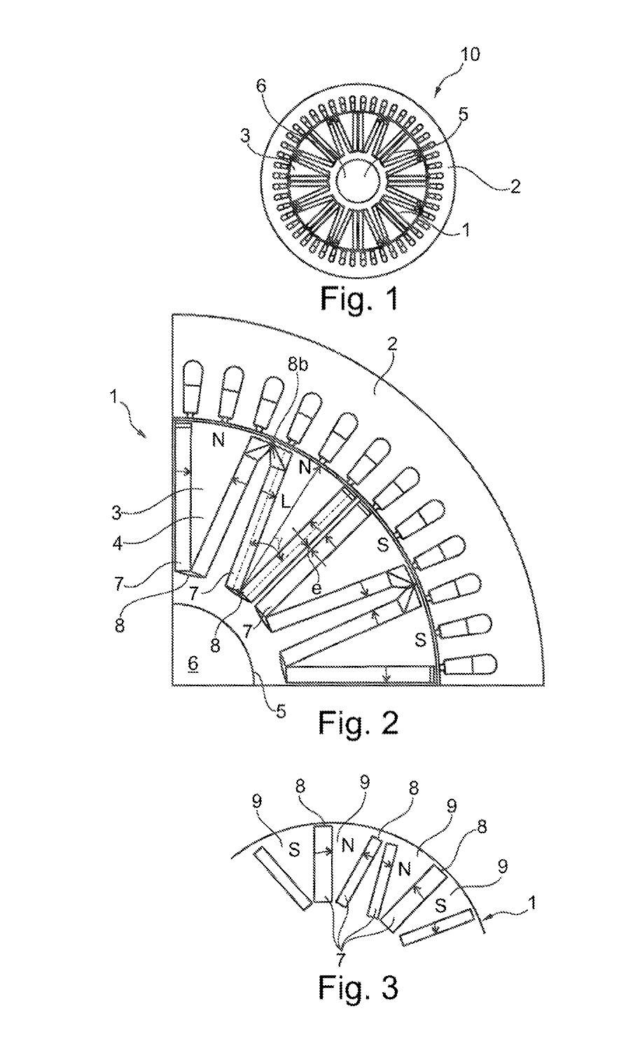

FIG. 1 schematically shows part of a machine comprising a rotor produced in accordance with the invention, in cross section,

FIG. 2 shows a detail of FIG. 1, and

FIGS. 3 to 11 and 5a are views similar to FIG. 2, illustrating variants.

FIG. 1 illustrates a rotating electric machine 10 comprising a rotor 1 and a stator 2.

The stator 2 comprises, for example, a concentrated or distributed winding. This stator makes it possible to generate a rotating magnetic field that rotates the rotor in the case of a synchronous motor, whereas, in the case of an alternator, the rotation of the rotor induces an electromotive force in the windings of the stator.

The rotor 1 shown in FIGS. 1 and 2 comprises a magnetic rotor body 3 extending axially along the axis of rotation X of the rotor, this rotor body being formed for example by a set of magnetic laminations 4 stacked in accordance with the axis X, the laminations for example being identical and superimposed exactly. They may be held together by clips, by rivets, by tie rods, soldered joints or any other technique. In a variant, the rotor body may comprise at least one wound magnetic lamination. The magnetic laminations are preferably made of magnetic steel. All variations of magnetic steel may be used.

The rotor body 3 comprises a central opening 5 for the mounting on a shaft 6. The shaft 6, in the example in question, may be made of a non-magnetic material, for example non-magnetic stainless steel or aluminum.

The rotor 1 comprises a plurality of permanent magnets 7 arranged in corresponding recesses 8 of the magnetic rotor body 3. The permanent magnets 7 are arranged in the shape of a V oriented toward the air gap. Each V defines an elementary polar portion 9, two consecutive elementary polar portions 9 having an identical polarity. These two elementary polar portions 9 define a magnetic pole of the rotor in the example in question. Two consecutive magnets 7 of the same magnetic pole and of the same elementary polar portion have identical polarities on their opposed faces.

The two branches of the V, in the example described, form an angle γ between 10° and 90°. In addition, the V may extend over a radial height L between 5 and 25 cm. The height L may be from 30% to 80% of the radius of the rotor, measured between the axis of rotation and the air gap.

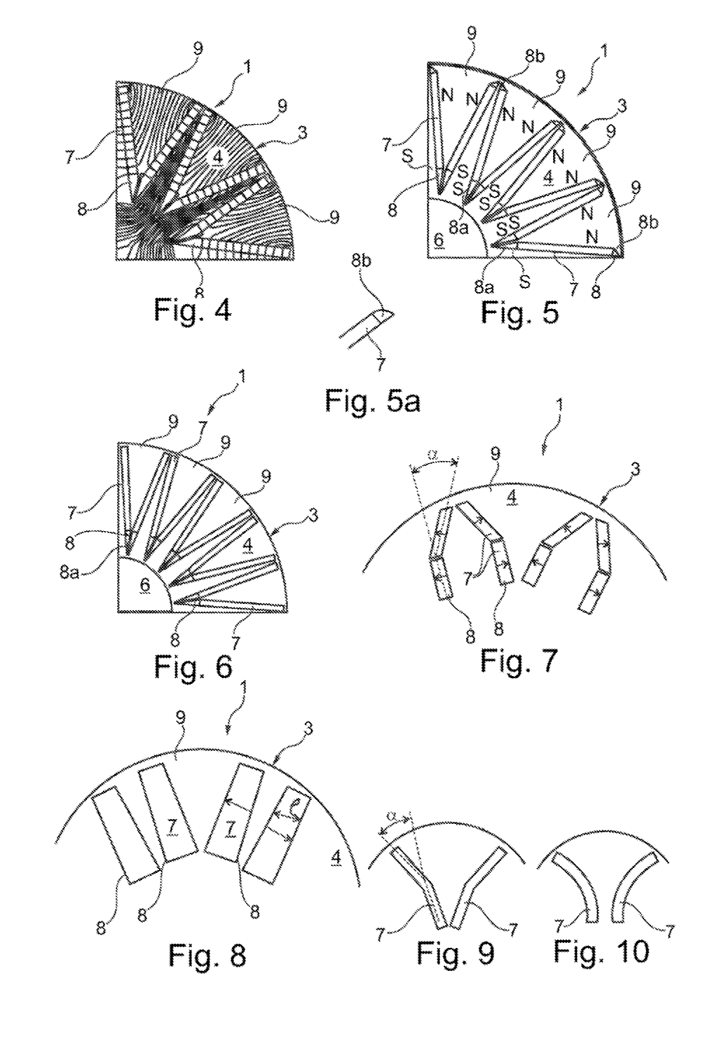

In a variant, three consecutive elementary polar portions may have an identical polarity, as illustrated in FIG. 4, or four consecutive elementary polar portions, as illustrated in FIG. 5, or even five consecutive elementary polar portions, as illustrated in FIG. 6. A primary magnetic pole of a rotor according to the invention has been illustrated in each of these figures.

The path of the magnetic field lines of a pole of the rotor has also been illustrated by way of example in FIG. 4, and an example of the choice of orientation of the magnetization of the magnets for a primary magnetic pole of the rotor has been illustrated in FIG. 5.

In the illustrated example, the permanent magnets 7 are generally rectangular in cross section, however there is no departure from the scope of the present invention if they have a different shape, for example a trapezoidal shape, as illustrated in FIG. 8. In this figure, it can be seen that the width l of a magnet in cross section perpendicularly to the axis of rotation becomes thinner in the direction of the air gap.

The magnets may be made of ferrite or, in a variant, of rare earths, for example of the neodymium type or the like. The magnets are preferably made of ferrite.

In the illustrated examples, two consecutive magnets of two consecutive elementary polar portions of identical polarity also form a V oriented toward the axis of rotation.

In addition, in the embodiments illustrated in FIGS. 4 to 6, two consecutive magnets of two consecutive elementary polar portions of opposed polarity also form a V oriented toward the axis of rotation.

Of course, the situation may be different, and in the exemplary embodiment illustrated in FIG. 1, two consecutive magnets of two consecutive elementary polar portions of opposed polarity extend substantially parallel to one another. Such an arrangement of magnets makes it possible to optimize the flux circulation in the rotor body. The thickness e of the rotor body between two consecutive magnets of two consecutive Vs of opposed polarity is between 1.5 and 5 mm in the example described.

In a variant illustrated in FIG. 3, a single magnet is involved in two Vs having two opposed polarities at the same time. The magnet is twice as large in cross section in the described example as a magnet involved in just a single V.

In the examples illustrated in FIGS. 4 to 6, the end 8a of the recess 8 closest to the axis of rotation is triangular in cross section perpendicularly to the axis of rotation.

In the example illustrated in FIGS. 1 and 2, the recesses each define branches of the same V communicating via their end 8a closest to the axis of rotation.

In a further variant or in addition, the two ends 8a and 8b of each recess 8 are triangular, as illustrated in FIG. 5.

The end 8b of the recess 8 may also comprise a curved edge in a variant, for example an edge curved in a circular arc, as illustrated in FIG. 5a.

In the examples that have just been described, a V is formed by two consecutive permanent magnets as considered circumferentially. Of course, there is no departure from the scope of the present invention if the situation is otherwise and if, for example, a V is formed by more than two permanent magnets as considered circumferentially. Each branch of a V may be provided for example by a number of permanent magnets, in particular two, or three or four. In an embodiment, a V may be formed in particular by four permanent magnets, two magnets for example forming each branch of the V, as illustrated by way of example in FIG. 7. The magnets forming a branch of a V may each extend along an axis, the two axes enclosing an angle α therebetween. This angle α may be between 0° and 90°.

In a variant, one branch of a V may be formed with a single magnet, comprising two rectilinear portions inclined with respect to one another by an angle α, as illustrated in FIG. 9.

In a further variant, the magnets may be curved, as illustrated in FIG. 10.

A synthetic material may be injected into the recesses 8 so as to lock the magnets in the recesses 8 and/or to ensure the cohesion of the laminated core. The material used is, for example, an epoxy resin or a thermoplastic material. The magnets 7 may also be locked in place by clamping under the action of the centrifugal force.

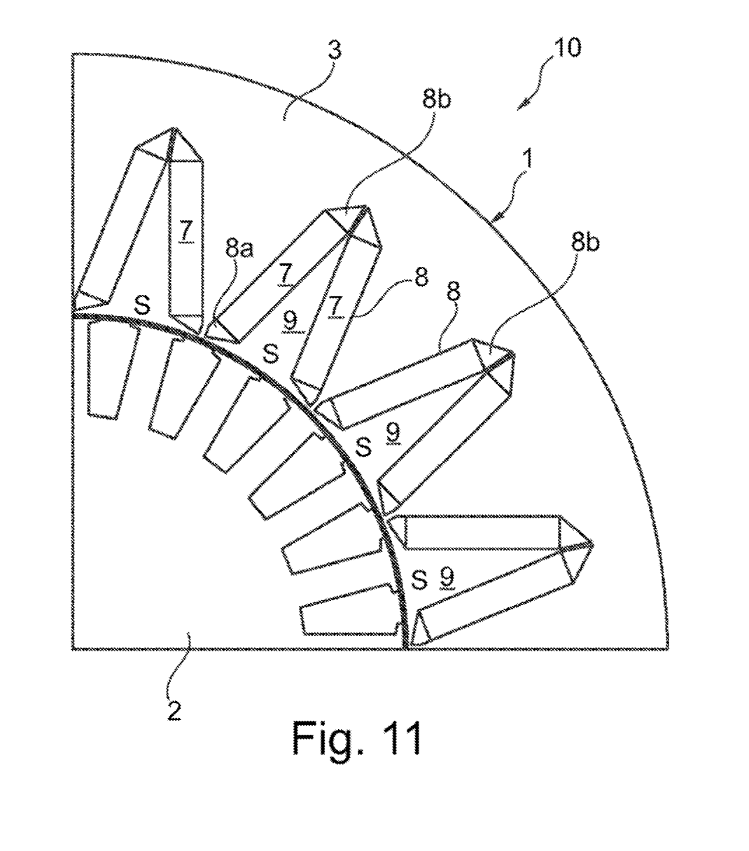

In all the examples just described, the rotor is an inner rotor, however there is no departure from the scope of the invention if the rotor is an outer rotor. By way of example, a machine 10 comprising an inner stator 2 and an outer rotor 1 has been illustrated in FIG. 11.

Of course, the invention is not limited to the embodiments that have just been described.

For example, the laminations may be formed with holes to allow the passage of tie rods for joining the laminations of the rotor body.

The expression “comprising a” should be understood as being synonymous with “comprising at least one”.

1. A rotor of a rotating electric machine with flux concentration, comprising:
a rotor body comprising recesses, and
permanent magnets arranged in the recesses of the rotor body, the permanent magnets being arranged in the shape of a V oriented toward the air gap, each V being formed by more than two permanent magnets and defining an elementary polar portion, at least two consecutive elementary polar portions having an identical polarity.

2. A rotor of a rotating electric machine with flux concentration, comprising:
a rotor body comprising recesses, and
permanent magnets arranged in the recesses of the rotor body, the permanent magnets being arranged in the shape of a V oriented toward the air gap, each V defining an elementary polar portion, at least two consecutive elementary polar portions having an identical polarity, the width of a magnet in cross section perpendicularly to the axis of rotation becoming thinner in the direction of the air gap.

3. A rotor of a rotating electric machine with flux concentration, comprising:
a rotor body comprising recesses, and
permanent magnets arranged in the recesses of the rotor body, the permanent magnets being arranged in the shape of a V oriented toward the air gap, each V defining an elementary polar portion, at least two consecutive elementary polar portions having an identical polarity, the permanent magnets being curved in cross section.

4. A rotor of a rotating electric machine with flux concentration, comprising:
a rotor body comprising recesses, and
permanent magnets arranged in the recesses of the rotor body, the permanent magnets being arranged in the shape of a V oriented toward the air gap, each V defining an elementary polar portion, at least two consecutive elementary polar portions having an identical polarity,
the rotor being outside the machine.

5. The rotor as claimed in claim 2, wherein a V is formed by two consecutive permanent magnets as considered circumferentially.

6. The rotor as claimed in claim 1, wherein a V is formed by four permanent magnets, two magnets each forming a branch of the V.

7. The rotor as claimed in claim 1, at least three consecutive elementary polar portions having an identical polarity, or at least four consecutive elementary polar portions, or even five consecutive elementary polar portions.

8. The rotor as claimed in claim 1, wherein the permanent magnets are rectangular in cross section.

9. The rotor as claimed in claim 1, wherein the width of a magnet in cross section perpendicularly to the axis of rotation becomes thinner in the direction of the air gap.

10. The rotor as claimed in claim 1, wherein the permanent magnets are curved in cross section.

11. The rotor as claimed in claim 1, wherein the consecutive magnets of two consecutive elementary polar portions of identical polarity form a V oriented toward the axis of rotation.

12. The rotor according to claim 1, wherein the consecutive magnets of two consecutive elementary polar portions of opposed polarity form a V oriented toward the axis of rotation.

13. The rotor according to claim 1, wherein the consecutive magnets of two consecutive elementary polar portions of opposed polarity extend substantially parallel to one another.

14. The rotor as claimed in claim 13, wherein the thickness of the rotor body between the consecutive magnets of two consecutive Vs of opposed polarity is less than 5 mm.

15. The rotor as claimed in claim 1, wherein at least one recess extends radially over a length greater than the radial length of the corresponding magnet, in cross section.

16. The rotor as claimed in claim 1, wherein at least one end of the recess in cross section perpendicularly to the axis of rotation is triangular or curved.

17. The rotor as claimed in claim 1, wherein the permanent magnets form a number of Vs between 8 and 24.

18. The rotor as claimed in claim 1, comprising a number of poles less than or equal to 8, or less than or equal to 6.

19. The rotor as claimed in claim 1, wherein the permanent magnets are made at least in part of ferrite.

20. The rotor as claimed in claim 1, comprising a number of pieces of rotor aligned in the axial direction and offset angularly relative to one another.

21. A rotating electric machine comprising a rotor as claimed in claim 1.

22. A rotating electric machine comprising a rotor as claimed in claim 1, the rotor being an outer rotor.
